(19) United States
(12) Patent Application Publication
(10) Pub. No.: US 2004/0094686 A1
(43) Pub. Date: May 20, 2004

(54) Device for holding a hand tool or flashlight

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/294,637

(22) Filed: Nov. 15, 2002

(51) Int. Cl. H01Q 1/12

(52) U.S. Cl. 248/537

(57) ABSTRACT

A device for holding an object has a triangle cross section and includes a plurality of flat surfaces. One of the flat surfaces has a magnet connect thereto and a groove is defined in one of peaks of the device so as to hold a flashlight or a hand tool.

### FIELD OF THE INVENTION

The present invention relates to a holding device that has a groove for holding a shank of a hand tool or a flashlight.

### BACKGROUND OF THE INVENTION

A conventional flashlight 10 and a hand tool 20 are respectively shown in FIGS. 1 and 2 and generally includes a cylindrical shank portion 11′/21′. The users randomly put the flashlight 10 and hand tools 20 in the working site so that they are easily get dirty and attached with grease or oil such that the users cannot hold them firmly. In fact, at a working site, it is difficult to put the flashlight 10 and the hand tool 20 properly because no such a device designed to position these items. If the shank portion is circular in shape, it rolls and could be stepped by the user or other people who does not notice them. Besides, when using the flashlight 10, the user has to hold the flashlight by one hand and operate a tool by the other hand. In other words, the user cannot user both his/her hands to operate tools.

The present invention intends to provide a device that has a large base with a magnet on the bottom and a groove for holding a hand tool or a flashlight.

### SUMMARY OF THE INVENTION

In accordance with one aspect of the present invention, there is provided a device for holding an object and the device comprises a plurality of flat surfaces and a groove is defined in the device and located at in opposite to one of the flat surface. A flashlight or a hand tool is engaged with the groove.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a flashlight;

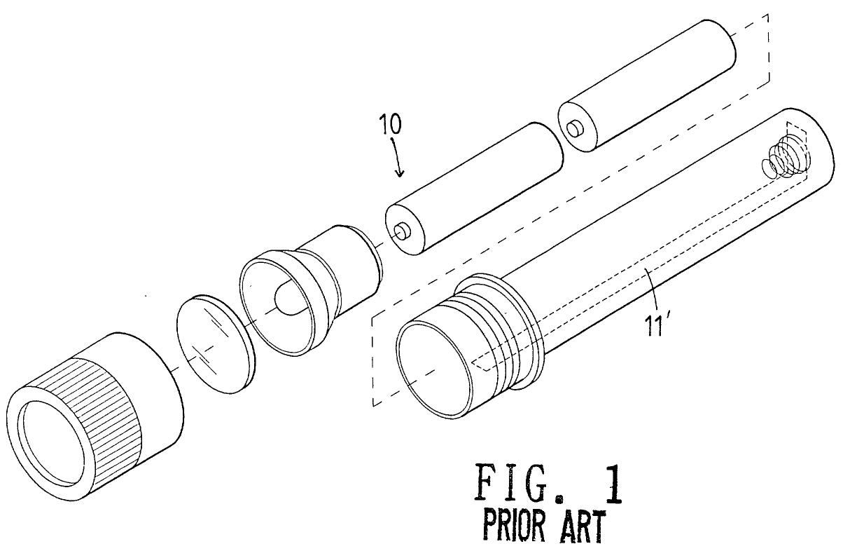

FIG. 2 is a perspective view to show a hand tool;

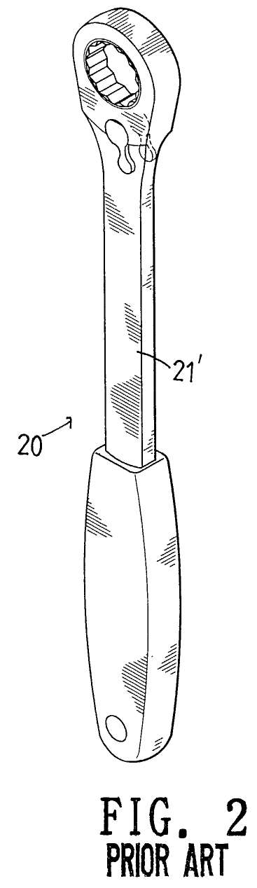

FIG. 3 is an exploded view to show the device of the present invention and a flashlight;

FIG. 4 shows the device of the present invention which has no weight connected thereto;

FIG. 5 shows the flashlight is engaged with the groove of the device of the present invention;

FIG. 6 shows the device of the present invention having a magnet and a flashlight;

FIG. 7 shows the flashlight is engaged with the groove of the device of the present invention as shown in FIG. 6, and

FIGS. 8 and 9 show two different types of hand tool are engaged with the groove of FIG. 5 shows the flashlight is engaged with the groove of the device of the present invention.

### DETAILED DESCRIPTION OF THE PREFERRED EMBODIMENT

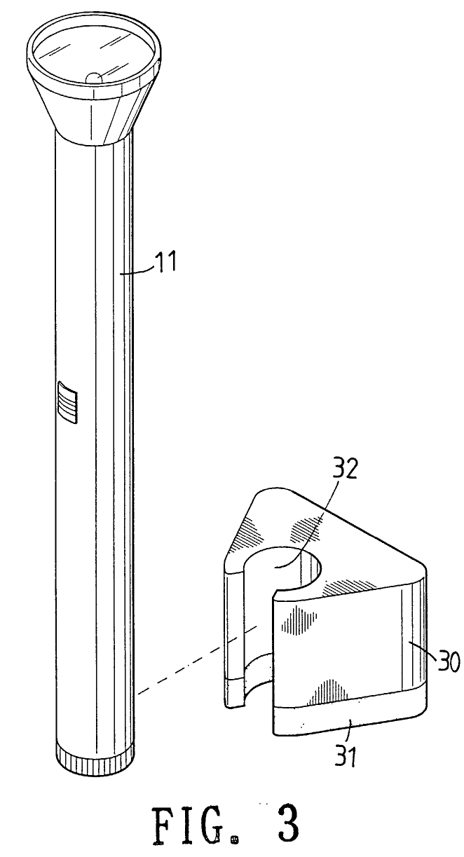

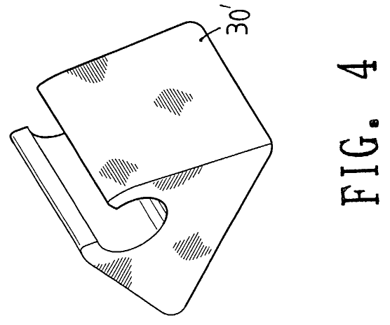

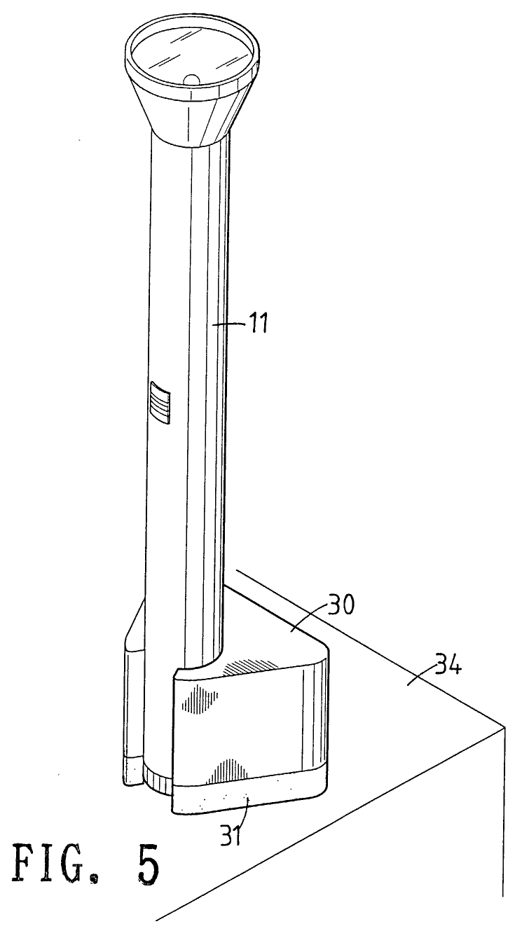

Referring to FIGS. 3 and 5, the device 30 for holing an object such as a flashlight 11 or a hand tool 21 of the present invention has a triangular cross section and comprises a plurality of flat surfaces and three peaks. A groove 32 is defined in one of the three peaks and located at in opposite to one of the flat surface. The device 30 is made of plastic and a weight 31 is connected to one of the flat surfaces of the device 30 so that the device 30 can be put on a desk 34 or ground. The device 30′ can also be made of heavy material as shown in FIG. 4.

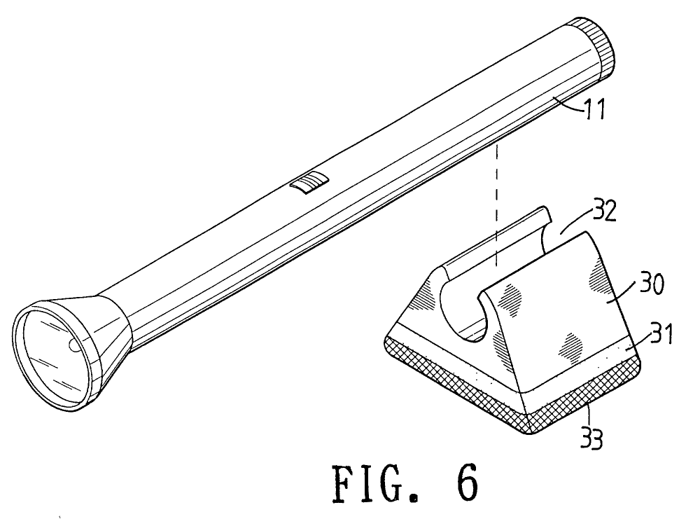

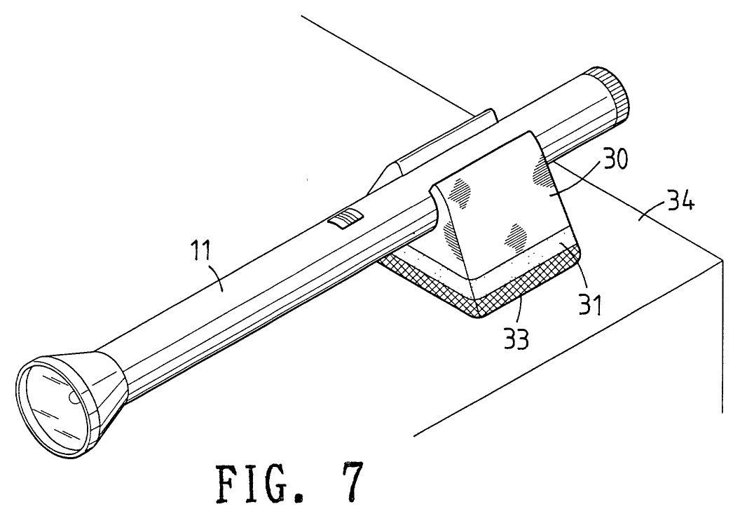

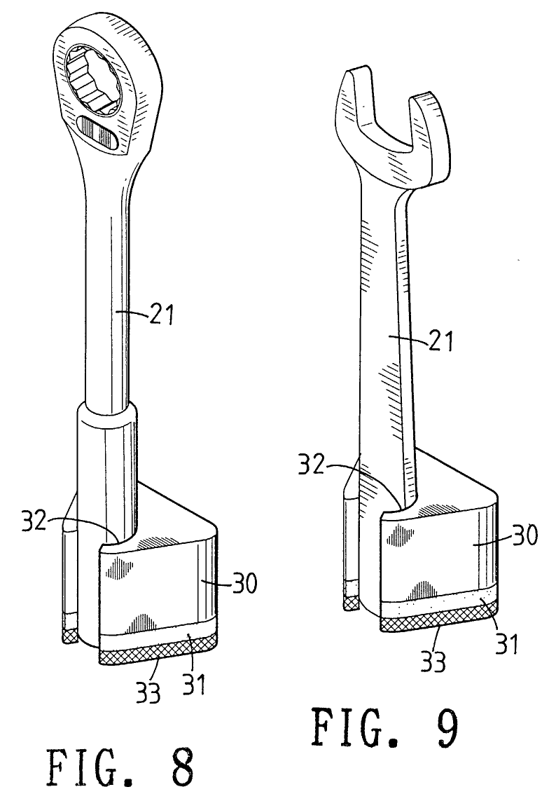

FIGS. 6 and 7, the device 30 may have a magnet 33 connected to the weight 31 and which allows the device 30 to be easily attached on a metal surface 34. Referring to FIGS. 8 and 9, different types of hand tool 21 can be held in the groove 32 of the device 30.

The shape of the device 30 can be vary and it can be made to be compact in volume so that even if the device 30 is connected to the flashlight 11 or the hand tool 21, the users still can operate them easily.

While we have shown and described the embodiment in accordance with the present invention, it should be clear to those skilled in the art that further embodiments may be made without departing from the scope of the present invention.

What is claimed is:

1. A device for holding an object, comprising:
a plurality of flat surfaces and a groove defined in the device, the groove located at in opposite to one of the flat surface.

2. The device as claimed in claim 1 further comprising a magnet connected to one of the flat surfaces.

3. The device as claimed in claim 1, wherein the device has a triangular cross section.

4. The device as claimed in claim 3, wherein the groove is defined in one of three peaks of the device.
